(19) United States
(12) Patent Application Publication
(10) Pub. No.: US 2017/0232400 A1
(43) Pub. Date: Aug. 17, 2017

(54) CERAMIC FILTER

(71) Applicant: MEIDENSHA CORPORATION, Tokyo (JP)

(72) Inventors: Hideya SHIRAISHI, Nagoya-shi (JP); Hiroshi Noguchi, Jourong West (JP); Akitoshi Nakakawa, Kiyosu-shi (JP); Takayuki Ugajin, Numazu-shi (JP); Satoru Seike, Ota-ku (JP); Toru Tsuchiya, Kiyosu-shi (JP); Yuki Matsuura, Kiyosu-shi (JP); Naoki Kato, Kiyosu-shi (JP)

(73) Assignee: MEIDENSHA CORPORATION, Tokyo (JP)

(21) Appl. No.: 15/101,458

(22) PCT Filed: Nov. 28, 2014
(86) PCT No.: PCT/JP2014/081496

§ 371 Date: Jun. 3, 2016

(30) Foreign Application Priority Data
Dec. 5, 2013 (JP) 2013-251594

(51) Int. Cl. B01D 71/02; B01D 67/00; B01D 69/12

(52) U.S. Cl. CPC B01D 71/025; B01D 69/12; B01D 71/027; B01D 67/0088

(57) ABSTRACT

A ceramic filter 20 has a porous support formed from particles containing a metal oxide as a main component and a membrane layer coated on a surface of the porous support and formed from particles containing the same kind of metal oxide as that of the porous support, wherein the particles forming the membrane layer are loaded with a different kind of metal oxide from that of the particles forming the membrane layer.

### FIELD OF THE INVENTION

The present invention relates to a ceramic filter for filtration of raw water for drinking water, domestic sewage and various kinds of wastewater.

### TECHNICAL BACKGROUND

A ceramic filter has a porous structure of large specific surface area produced by mixing particles of ceramic material such as alumina and a binder etc., molding the ceramic particle mixture, and then, sintering the molded product at high temperatures under atmospheric pressure. The porous structure consists of a plate- or cylindrical tube-shaped porous support made of coarse particles and one or more membrane layers made of fine particles on the porous support. The ceramic filter has advantages of robustness, resistance to physical/chemical stress and hydrophilicity, and thus is used for various kinds of wastewater.

A Polymeric membrane is made of a polymer material such as a polysulfone resin. Such a polymer material is hydrophobic and has affinity with hydrophobic substances such as proteins, fats and oils, which cause membrane fouling. Thus, the polymeric membrane is easily fouled. It is common to apply surface treatment to the polymeric membrane with a surfactant to make the membrane surface hydrophilic.

In contrast, the ceramic filter has advantage that fouling can be avoided since the ceramic material has high hydrophilicity so as not to be easily plugged with foulants. The membrane surface of the ceramic filter is smooth and can be easily cleaned.

However, it is difficult to completely suppress fouling due to the presence of foulants in water. Improvement such as improvement of membrane cleaning process is still required.

In the case of a membrane bioreactor (MBR) using a ceramic membrane, fouling is suppressed by performing air scouring and chemical cleaning during stop of filtration.

Various attempt have been made to suppress membrane fouling. In particular, it is effective to make the surface charge of a membrane to be the same as the charge of foulants. This results in suppression of fouling and reduction of energy consumption and so on. (See, for example, Patent Documents 1 and 2).

For example, Patent Document 1 discloses that, in the case of removing fine particles from an aqueous suspension with the use of a filter, fouling is suppressed by applying a coating of titanium dioxide to a porous support of the filter in view of surface charge.

Patent Document 2 discloses that, during operation of a pressurized type PVDF (polyvinylidene fluoride) ultrafiltration membrane module, fouling is suppressed by controlling a negatively charged surface of the membrane according to a measurement value of the zeta potential.

Patent Documents 3 to 5 disclose application of silica, titania and zirconia etc., which are known to be effective for suppression of fouling, for ceramic filters.

Patent Document 3 discloses a ceramic filter having a substrate (porous support), an intermediate layer and a membrane layer. The membrane layer contains a ceramic powder and 5 to 25 mass % of an inorganic binder such as clay, kaolinite, titania sol, and silica sol or glass frit with a particle size of less than 1 μm. The titania sol or silica sol is a dispersion of titania (TiO₂) or silica (SiO₂) nano-size particles in water.

Patent Document 4 discloses a ceramic filter having a multilayer structure in which membrane layers are formed on a porous substrate (porous support) by using a silica sol. A MF (microfiltration) membrane or an UF (ultrafiltration) membrane is used as the porous support.

Patent Document 4 discloses a ceramic filter having a porous ceramic membrane layer formed on a porous substrate (porous support). The membrane layer is formed from zirconia particles and has a surface roughness Ra of 1 μm or less.

When a metal oxide which can suppress fouling is used as a main component of a slurry for formation of a membrane layer on a porous ceramic substrate (porous support), cracks and pin-holes are easily generated during sintering because of difference in shrinkage amount and rate between the membrane layer and the porous support. Such membrane defects are more easily generated with increase in the thickness of the membrane layer.

The metal oxide can be silica, titania, zirconia, ceria, iron oxide, tungsten oxide etc., a mixture of these compounds, or a metal oxide complex such as aluminosilicate or titaniasilicate, in sol or powder form.

The present invention was made in view of the above background. The present invention provides a ceramic filter having a membrane layer surface-modified without generating cracks and pin-holes in the membrane layer.

### REFERENCES

### Patent Documents

Patent Document 1: Japanese Laid-Open Patent Publication No. 2002-136969
Patent Document 2: Japanese Laid-Open Patent Publication No. 2010-227836
Patent Document 3: Japanese Laid-Open Patent Publication No. 2001-260117
Patent Document 4: Japanese Laid-Open Patent Publication No. 2012-40549
Patent Document 5: Japanese Laid-Open Patent Publication No. 2007-254222
Patent Document 6: Japanese Laid-Open Patent Publication No. S63-274407
Patent Document 7: Japanese Laid-Open Patent Publication No. H07-41318
Patent Document 8: Japanese Laid-Open Patent Publication No. H06-329412
Patent Document 9: Japanese Laid-Open Patent Publication No. H06-316407
Patent Document 10: Japanese Laid-Open Patent Publication No. 2000-290015
Patent Document 11: International Publication No. WO 2007/000916
Patent Document 12: Japanese Laid-Open Patent Publication No. 2006-335635
Patent Document 13: Japanese Laid-Open Patent Publication No. 2006-182604
Patent Document 14: Japanese Laid-Open Patent Publication No. 2004-131346

### SUMMARY OF THE INVENTION

The present invention describes a method of forming a membrane layer by using the same kind of metal oxide as that of a porous support and a different kind of metal oxide from that of particles of the membrane layer, so as to apply surface modification without generating cracks in the membrane layer.

Namely, the present invention provides a ceramic filter which has a porous support formed from particles containing a metal oxide as a main component and a membrane layer coated on a surface of the porous support and formed from particles containing the same kind of metal oxide as that of the porous support, wherein the particles forming the membrane layer are loaded with a different kind of metal oxide from that of the particles forming the membrane layer.

The present invention enables surface modification of the membrane layer without generating pin-holes and cracks in the membrane layer.

### BRIEF DESCRIPTION OF THE DRAWINGS

FIG. 1 shows the zeta potential for components of a membrane layer.

FIG. 2 shows a SEM image of a ceramic filter produced by a method according to the present invention.

FIG. 3 shows a SEM image of a ceramic filter produced by a conventional method for comparison.

FIG. 4 shows a schematic diagram of test equipment to conduct filtration test for the ceramic filter produced by the method according to the present invention or by the conventional method.

### DETAILED DESCRIPTION OF THE EMBODIMENTS

The present invention has been accomplished as a result of extensive researches made on the production of a ceramic filter with a porous ceramic support formed using a powder of alumina as a component material and a membrane layer on a surface of the porous ceramic support and formed using alumina as a main component in combination with a metal oxide different from alumina, such as silica, titania, zirconia, ceria, iron oxide or tungsten oxide, or a mixture of these metal oxides, to make a surface charge derived from the different metal oxides.

When a membrane layer is composed of alumina particles that are coated with a metal oxide such as silica, titania, zirconia, ceria, iron oxide, tungsten oxide etc. or a mixture of these metal oxides, the surface charge of the membrane layer can be modified according to the metal oxide coated on the alumina particles. Thus, the metal oxide or metal oxide mixture functions as the material for surface modification of the alumina particles.

When a membrane layer is composed of alumina particles that are coated with a metal oxide such as silica, titania, zirconia, ceria, iron oxide, tungsten oxide etc. or a mixture of these metal oxides, pin-holes and cracks as defects are easily generated during sintering in production process because the different metal oxides have different amounts of shrinkage and different rates of shrinkage during sintering. The generation of such defects in the membrane layer becomes more probable with increase in the thickness of the membrane layer.

For this reason, it is necessary to select, as a component material for the membrane layer, the same kind of material as that of the porous support so as to minimize difference in shrinkage between the membrane layer and the porous support.

Furthermore, a production procedure of the ceramic filter according to the present invention can be the same as conventional process except adding a material for surface modification.

In general, the pore size of the porous support is determined by the size of the particles consisting of the porous support. The larger the size of the particles, the lower the packing density, which results in the larger size of the pores. The large pores remain even after sintering. It is thus possible to adjust the pore size of the membrane filter after sintering according to the particle size of the raw material of the membrane filter. If smaller particles are added in an excessive amount, the open porosity and the pore size of the membrane layer are decreased after sintering so that a suitable pore size cannot be obtained. Accordingly, the present invention adds the surface modification material to surface-modify the main component material for the membrane layer, without causing large changes in filtration properties such as pore size of the membrane layer.

Hereinafter, the embodiment of the present invention will be described below.

1. Conditions for Producing the Ceramic Filter

An embodiment sample of ceramic filter according to the present invention is produced by using a porous support which is commonly used for ceramic filter (formed using e.g. alumina as a main component material). A slurry is coated on a surface of the porous support, and then, then dried and sintered to form a membrane layer on the surface of the porous support. The shape of the ceramic filter is a flat sheet shape (plate shape).

The procedure for providing the porous support and the slurry for formation of the membrane layer will be explained below with reference to conventional process.

(1-1) Porous Support

The porous support is formed using a metal oxide as a component material. Examples of the metal oxide used as the component material for the porous support are alumina (Al₂O₃), silica (SiO₂), cordierite (2MgO.2Al₂O₃.5SiO₂), titania (TiO₂), mullite (Al₂O₅.SiO₂), zirconia (ZrO₂), spinel (MgO.Al₂O₃) and mixtures of these materials. Among others, alumina, titania, silica and zirconia are preferred since these metal oxides are commercially available as the raw material with a desired average particle size.

In view of the purpose of use of the ceramic filter, the average particle size of the main component material for the porous support is preferably in the range of 1 to 100 μm.

When the pore size of the porous support is large, the membrane layer may be coated on the porous support via an intermediate layer without being directly coated on the porous support. The porous support can be in cylindrical tube form, plate form or monolith form.

In the present embodiment, the porous support is plate-shaped and formed from alumina (0.7 μm or 3 μm average particle size) as the main component.

For example, it is feasible to form the porous support by mixing alumina as the main component material with a binder, an inorganic sol and water, molding the alumina mixture and then drying and sintering the molded product as disclosed in e.g. Patent Document 7. It is alternatively feasible to utilize a substrate (support body) as exemplified in e.g. Patent Document 3 or to utilize a known substrate (support body) components or support body.

(1-2) Membrane Layer

The membrane layer is formed using a main component material and a material for surface modification. The slurry containing the main component material and the surface modification material is used for coating on the porous support.

The component material for the membrane layer is the same kind of metal oxide as that for the porous support. Examples of the metal oxide used as the main component material of the membrane layer are those listed above as the examples of the main component material of the porous support.

The component material for the membrane layer is ceramic particles. The pore size of the membrane layer is determined by the average particle size of the component material for the membrane layer. In view of the purpose of use of the ceramic filter, the average particle size of the component material for the membrane layer is preferably in the range of 0.01 to 1 μm.

In the present embodiment, the membrane layer is formed from alumina particles with average particle size of 0.4 μm (as exemplified in e.g. Patent Documents 7 and 8) as the main component material.

On the other hand, the average particle size of the material for surface modification is smaller than the average particle size of the main component material of the membrane layer in order to obtain the effects of the present invention without causing changes in filtration properties such as open porosity and particle retention rate by the addition of the material for surface modification. Thus, the average particle size of the material for surface modification is set to be smaller than or equal to 1/1, preferably smaller than or equal to 1/10, of the average particle size of the main component of the membrane layer.

In the present embodiment, the average particle size of the material for surface modification is set smaller than or equal to 1/10 of the average particle size 0.4 μm of the alumina particles as the component material of the membrane layer (i.e., the average particle size of the material for surface modification is set to 40 nm or smaller). The material for surface modification can be any different kind of metal oxide from that used as the main component material of the membrane layer. For example, the material for surface modification is selected from the following six kinds of metal oxides and used in the form of a metal oxide sol with an average particle size of 66 nm or 15 nm: silica (silica sol; see e.g. Patent Document 9), titania (titania sol; see e.g. Patent Document 10), zirconia (zirconia sol; see e.g. Patent Document 11), ceria (ceria sol; see e.g. Patent Documents 12 and 13), iron (III) oxide (iron oxide sol; see e.g. Patent Document 13) and tungsten oxide (tungsten oxide sol; see e.g. Patent Document 14). As the iron oxide, there can be used not only iron (III) oxide (Fe₂O₃) but also FeO or Fe₃O₄.

In the preparation of the slurry for formation of the membrane layer, an aqueous acrylic acid dispersant (available under the trade name of e.g. Aron A-611A from Toagosei Co., Ltd.) can be used as a dispersant; and an aqueous acrylic binder (available under the trade name of e.g. Aron AS-1800 from Toagosei Co., Ltd.) can be used as a binder.

The material for surface modification can be added to the slurry in the form of a sol or powder of metal oxide. For example, it is possible to prepare the slurry for formation of the membrane layer by adding deionized water to the material for surface modification to thereby provide an aqueous solution containing 0.1 to 50 mass % of the material for surface modification based on 100 mass % of the main component material, adding the dispersant in an amount of 0.1 to 10 mass % (for example, 0.4 mass % in the present embodiment) relative to the total amount of the aqueous solution and adding the binder in an amount of 0.1 to 1.1 mass % (for example, 0.1 mass % in the present embodiment) relative to the total amount of the main component material and the material for surface modification.

When the material for surface modification modifier is added in an amount exceeding 50 mass % relative to the component material, it is likely that membrane defects such as pinhole or crack will occur in a surface of the membrane layer during drying or sintering. For this reason, the amount of the surface modification material added is preferably 50 mass % or less relative to the amount of the component material.

Further, the isoelectric point of the membrane layer (at which the zeta potential becomes 0) shifts to a low pH side when the amount of the material added for surface modification is 0.1 mass % or more relative to the amount of the main component material.

In the present embodiment, the membrane layer is formed with a thickness of the order of 400 μm on the porous support. The thickness of the membrane layer can be properly set within the range of 10 to 100 μm to suppress generation of the defects and to retain permeability.

The prepared slurry is used for formation of the membrane layer on the surface of the porous support. The slurry is sprayed, dried by hot air blowing, and then, sintered.

It is feasible to apply the slurry to the porous support by a known method such as not only spraying but also dip coating method.

The sintering temperature is varied depending on the kinds of the main component material and other constituent components. When alumina is used as the main component material of the membrane layer, for example, the sintering is performed under the sintering conditions of e.g. 800 to 1600° C. for 1 hour. The sintering may be performed at a higher temperature so as to increase the strength of membrane filter. The sintering may be performed at a lower sintering temperature with the addition of a sintering aid to the slurry. Although the sintering temperature is set to 1370° C. in the present embodiment, the sintering temperature can be properly set depending on the material composition, sintering conditions etc.

In the case of the inner-pressurized type membrane, the membrane layer is formed on an inner surface of the porous support. On the other hand, the membrane layer is formed on an outer surface of the porous support in the case of the outer-pressurized type membrane.

For example, the membrane layer is formed on the inner or outer surface of the porous support when the support body is hollow cylindrical-shaped. When the porous support is plate-shaped, the membrane layer is formed on the surface of inner channels made in parallel to a width direction of the porous support, or on both sides of the porous support. When the porous support is monolith-shaped, the membrane layer is formed on the inner surface of multi holes made in an axial direction of the porous support or on the outer surface of the porous support.

The particle sizes of alumina used as the main component for the membrane layer and the metal oxide such as silica, titania, zirconia, ceria, iron oxide or tungsten oxide used as the main component material for surface modification can be determined by conventional methods. For examples, the particle sizes of silica, titania and zirconia can be measured by the following methods.

Particle size of alumina, titania: determined by laser diffraction scattering particle size distribution analysis (in compliance with JIS Z8825-2005: “Particle size analysis—Photon correlation spectroscopy”)

Particle size of silica: determined by BET adsorption method (in compliance with JIS Z8830-2013).

Particle size of zirconia: determined by analysis of a TEM image (in compliance with JIS 7804-2005).

2. Results of Measurement and Observation of Surface Charge and Surface Properties of Ceramic Filter.

Samples were produced according to the embodiment of the present invention as mentioned above. Further, a comparative sample was produced. Observation of the surfaces of the samples (surface charge and surface properties) and water filtration tests were conducted to evaluate effects of the surface modification. The results are as follows.

(2-1) Surface Charge of Membrane

Slurries for formation of membrane layers were sintered with the same conditions for producing the membrane layer. Sintered sample were obtained for measurement of the zeta potential.

The slurry for formation of the membrane filter was prepared by using alumina particles (average particle size 0.4 μm) as the main component material and adding 25 mass % or 50 mass % of silica or 20 mass % of titania as the material for surface modification.

The prepared slurries were sintered. The obtained sintered samples were crushed and used for measurement of the zeta potential.

The measurement of the zeta potential was conducted by using a particle size analyzer (Zetasizer Nano ZS, Malvern Instruments), a capillary column and an automatic dropping machine MTP-2 (Malvern Instruments).

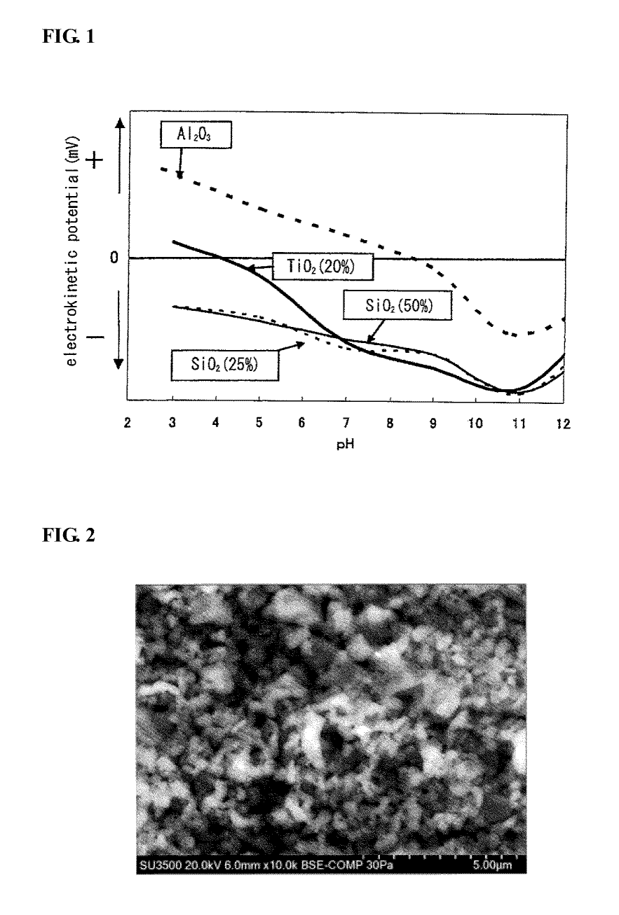

The results of the surface charge measurement are shown in FIG. 1. In FIG. 1, Al₂O₃ (alumina) was the same as a conventional ceramic filter membrane layer without surface modification.

From the results of the samples with 25 mass % and 50 mass % of silica (“SiO₂ (25%)” and “SiO₂ (50%)”) and the result of the alumina sample (“Al₂O₃”), the zeta potential of the silica-containing samples was shifted to a negative relative to that of the alumina sample over a wide pH range. This shows the effects of the surface modification. Since there was no apparent difference between the measurement results depending on the silica content (25 mass % and 50 mass %), the influence of the amount of the surface modification material on the modification effects was small.

Similar results were obtained for the alumina powder with different size ranged from 0.4 μm to 0.01, 0.3, 0.5 or 1 μm. Even when any surface modification material other than silica, such as titania, zirconia, ceria, iron oxide or tungsten oxide, having an average particle size of 6 nm or 15 nm was used, similar results were obtained as long as the average particle size of the alumina powder was 0.01 to 1 μm. Further, similar results was obtained when silica, titania, zirconia, ceria, iron oxide or tungsten oxide was in an amount of 0.1, 0.2, 1 or 5 wt % as the material for surface modification.

Moreover, various powders for surface modification were mixed with alumina (Al₂O₃) powder. The isoelectric point (at which the zeta potential was 0 mV) of the powder samples was measured. Whereas the isoelectric point of the alumina sample was 9.1, the isoelectric point of the titania-containing sample was 6.7; the isoelectric point of the silica-containing sample was 1.8 to 2.7; the isoelectric point of the zirconia-containing sample was 6.5; the isoelectric point of the ceria-containing sample was 6.5; the isoelectric point of the iron oxide-containing sample was 8.3; and the isoelectric point of the tungsten oxide-containing sample was 0.5. It is apparent from these results that the zeta potential was shifted to a negative side by mixing the alumina with these metal oxides for the surface modification.

It is shown from the above results that effects of the surface modification are obtained for the alumina when the average particle size of the alumina particles is in the range of 0.01 to 1 μm; the average particle size of the particles for surface modification is smaller than equal to 1/10 of the average particle size of the alumina particles; and the particles for surface modification is added in an amount of 0.1 to 50 wt % to the alumina particles.

(2-2) Results of Surface Observation of Membrane Layer by Scanning Electron Microscope (SEM)

SEM observation of the embodiment samples and the comparative sample was carried out to examine the morphology of the surface-modified samples.

A slurry was prepared by adding 50 mass % of silica sol (average particle size 15 nm) as the material for surface modification to alumina particles (average particle size 0.4 μm) as the main component material for the membrane layer. The embodiment samples were produced by using this slurry. The comparative sample was produced without adding silica in the above procedure.

The SEM images of the surface-modified sample and the comparative sample are shown in FIGS. 2 and 3, respectively. From FIG. 2, there was no aggregation in the surface-modified sample. Further, the coverage of silica on the alumina particle was confirmed by comparison of FIGS. 2 and 3. Similar results were obtained when titania, zirconia, ceria, iron oxide or tungsten oxide was used for surface modification. It is thus shown that, by adding the metal oxide to the alumina particles, it is possible to uniformly cover the surfaces of the alumina particles with the material for the surface modification.

3. Filtration Test with Synthesized Wastewater

The embodiment sample and the comparative sample were tested for filtration of synthesized wastewater. The test procedure and results are as follows.

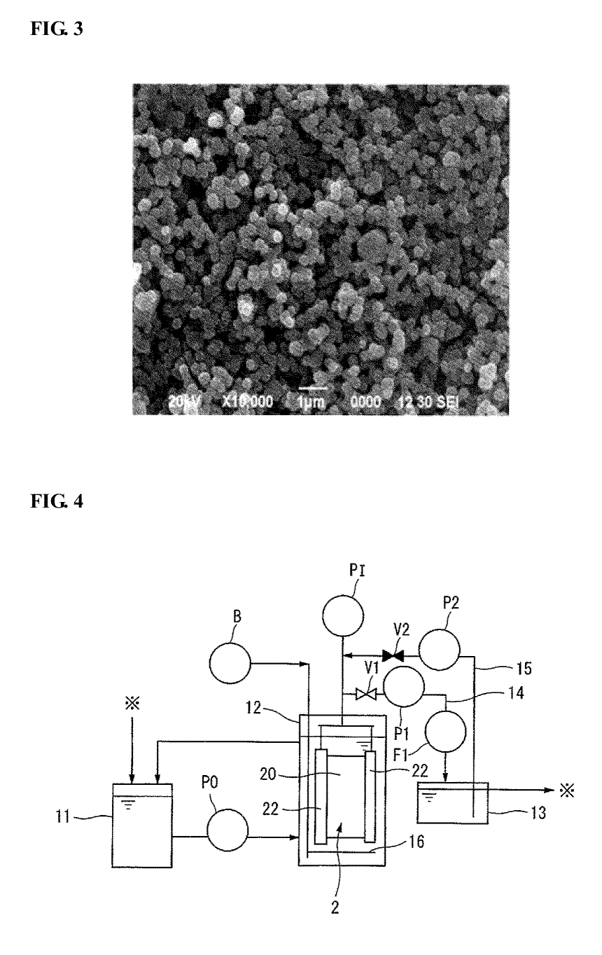

The filtration test was performed at room temperature by using test equipment of FIG. 4. The synthesized wastewater was fed as raw water by a feed pump PO at a flow rate of 200 ml/min from a raw water tank with volume of 11 to a membrane filtration tank 12 (net volume 3 l). The water overflowing from the membrane filtration tank 12 was returned to the raw water tank 11. The ceramic filter 20 as the embodiment sample (or comparative sample) had a flat sheet shape (width W 80 mm×height H 250 mm) and was immersed in the membrane filtration tank 12. The wastewater in the membrane filtration tank 12 was sucked by a filtration pump P1 and thereby filtered through the ceramic filter 20 at a filtration flux of 1.0 m³/(m²·day). Herein, the filtration flux is the rate of filtration per unit membrane area.

During the filtration, a valve V1 in a filtration line 14 was opened; and a valve V2 in a backwash line 15 is closed. The water to be treated was sucked from the outer side to the inner side of the ceramic filter 20. The filtered water inside the ceramic filter 20 was then fed to a filtered water tank 13 through a water collecting unit 22. The filtered water overflowing from the filtered water tank 13 was returned to the raw water tank 11. The flow rate of the filtered water was measured by a flowmeter F1. The differential pressure of the membrane module 2 was measured by a pressure gauge P1.

For cleaning the ceramic filter 20 (i.e. filter as the embodiment sample or the comparative sample), scrubbing air was supplied at a flow rate of 1.0 l/min from a blower B to the ceramic filter 20 through a diffusion pipe 16. For backwashing of the ceramic filter 20, the valve V1 was closed; the valve V2 was opened; and then the filtered water was fed back by a backwash pump P2 at a flow rate of 1.0 m³/(m²·day) from the filtered water tank 13 to the ceramic filter 20. The scrubbing was applied continuously. The backwashing was done for 1 minute every 14 minutes.

The synthesized wastewater was prepared as follows for the filtration test.

Synthesized wastewater: prepared by adding 200 mg/l of light oil to tap water, mixing the water at 0.3 Hz for 10 minutes or more with the use of a shaking machine and adding 100 mg/l of kaolinite to the mixed water.

The water quality of the synthesized wastewater was as follows: biochemical oxygen demand (BOD)=6 me; Chemical Oxygen Demand for Potassium Dichromate (COD_{Cr})=12 mg/l; and Suspended Solids (SS)=104 mg/l.

The BOD, COD_{Cr} and SS of the synthesized wastewater were determined according to testing methods for industrial wastewater (JIS K 0102). Further, oil in the synthesized wastewater was extracted with an extraction solvent (H-997 (Horiba Ltd.)) and measured by a non-dispersive infrared oil concentration meter (OCMA-305 (Horiba Ltd.))

Filtration conditions were as follows: flow rate: 1.0 m³/(m²·day); filtration time: 14 minutes; backwashing time: 1 minute; ratio of filtration flow rate and backwashing flow rate=1; air feed amount: 1.0 l/min; and measurement instruments: pressure gauge P1 (GC61-174 (Nagano Keiki)) and flowmeter F1 (FD-SS02A (Keyence)). The results of the filtration tests are shown in TABLE 1.

In TABLE 1, the water permeability is given in terms of a flux (m³/(m²·day)) of pure water at 100 kPa and 25° C.; and the open porosity is given in terms of a percentage of open pores relative to an outer volume of the sample as measured in compliance with ASTM-D-792.

TABLE 1

| | | Embodiment | Comparative |
|---|---|---|---|
| Item | | sample | sample |
| Material for surface | | silica | — |
| modification | | | |
| Amount of material | mass % | 50 | 0 |
| for surface | | | |
| modification | | | |
| Water permeability | m³/(m² · day) | 23.5 | 23.8 |
| Open porosity | % | 44.7 | 45.0 |
| Pore size | μm | 0.06 | 0.07 |
| TMP increase | kPa/day | 3.2 | 11.1 |
| rate | | | |
| | ratio relative to | 0.29 | 1 |
| | comparative sample | | |

As is seen from TABLE 1, the water permeability, open porosity and pore size of the surface-modified sample are the same as those of the comparative sample. This shows that the filtration performance of the embodiment sample was the same as that of the comparative sample.

On the other hand, the TMP increase rate of the embodiment sample was reduced by 71% relative to that of the comparative sample. It is thus shown that membrane fouling was suppressed in the embodiment sample.

To examine the influence of the amount of the surface modification material added to the membrane layer on the TMP increase rate, the same tests were performed on filters in which silica was added in an amount of 0.1, 0.2, 1, 5, 25 or 50 mass % based on 100 mass % of alumina (average particle size 0.4 μm) in membrane layers.

As results of the tests, the TMP increase rate of the samples with silica content of 0.1, 0.2, 0.4, 0.5, 1, 5 and 2 mass % was 0.5 or less relative to that of the comparative sample. Thus, it is concluded that the TMP increasing rate was suppressed by the surface modification of the membrane layer with silica in the range of 0.1 to 50 mass %.

Similarly, suppression of the TMP increase rate by the surface modification was shown when titania, zirconia, ceria, iron oxide or tungsten oxide was added in an amount of 0.1, 0.2, 1, 5, 25 or 50 wt % to the alumina (average particle size 0.4 am). Similar effects were shown when the alumina powder was used with average particle size of 0.01, 0.3, 0.5 or 1 μm.

Even when any surface modification material other than silica, such as titania, zirconia, ceria, iron oxide or tungsten oxide, having an average particle size of 6 nm or 15 nm was used, similar effects were observed as long as the average particle size of the alumina powder was 0.01 to 1 μm.

As in the case of the results of the surface charge measurement, it is shown from results of the above-mentioned synthesized water filtration test that the effects of the surface modification are obvious when the average particle size of the main component material is in the range of 0.01 to 1 μm; the average particle size of the surface modification material is smaller than or equal to 1/10 of the average particle size of the main component material; and the amount of the surface modification material is 0.1 to 50 mass % to the main component material. The influence of the amount of the surface modification material on the modification effects was small.

4. Characterization of Embodiment Samples and Comparative Samples

A slurry for formation of a membrane layer was prepared by using a main component material covered with a material for surface modification according to the above-mentioned procedure. The slurry was sprayed on a porous support, dried and sintered to obtain a ceramic filter. The membrane layer of the obtained ceramic filter was characterized by various methods. In each of the embodiment samples and the comparative sample, alumina (average particle size 3 μm) was used as the main component of the porous support; and alumina particles (average particle size 0.4 μm) were used as the main component material of the membrane layer.

The properties of the slurry in which silica or titania was used as the material for surface modification in each of the embodiment samples 1 to 3 are shown in TABLE 2. It is noted that, in the comparative sample 1, no surface modification material was added to the slurry for formation of the membrane layer.

TABLE 2

| | Main | Material for surface modification | | |
|---|---|---|---|---|
| | component | | Particle | Added |
| | material | | size | amount |
| | Compound | Compound | (nm) | (mass %) |
| Embodiment | alumina | silica | 15 | 25 |
| sample 1 | | | | |
| Embodiment | alumina | silica | 15 | 50 |
| sample 2 | | | | |
| Embodiment | alumina | titania | 6 | 20 |
| sample 3 | | | | |
| Comparative | alumina | — | — | — |
| sample 1 | | | | |

The results of the characterization of the embodiment samples and the comparative sample are shown in TABLE 3. The ceramic filter of the comparative sample 1 was produced without the addition of the material for surface modification.

In TABLE 3, the open porosity and particle retention are measured by the following methods.

The particle retention is defined as the retention rate (%) of standard particles with particle size of 0.1 μm. The value of the particle retention was obtained according to the procedure described in JIS R 1680-2007. The standard particles used were polyethylene particles (product name: SSR Size Standard Particles, average particle size: 0.1 μm).

TABLE 3

| | Open porosity (%) | Particle retention rate (%) |
|---|---|---|
| Embodiment | 45.45 | 95.99 |
| sample 1 | | |
| Embodiment | 45.28 | 95.27 |
| sample 2 | | |
| Embodiment | 47.73 | 96.94 |
| sample 3 | | |
| Comparative | 45.00 | 95.00 |
| sample 1 | | |

As is seen from TABLE 3, the membrane layers of the ceramic filters for embodiment samples 1 to 3, in which the material for surface modification (silica or titania) was applied to the alumina material, had the same level of open porosity as that of the comparative sample 1 as a conventional ceramic filter in which the material for surface modification was not added. The porosity of the membrane layer was retained, without being decreased, even with the addition of the material for surface modification. Since the ceramic filters of embodiment sample 1 to 3 had the same level of particle retention as that of the comparative sample 1, it is confirmed that there were no defects such as pinhole and crack in the membrane layer.

Consequently, the filtration performance of the membrane layer in which the material for surface modification (silica or titania) was applied to the main component material was equivalent to that of the comparative sample 1.

Similar results were obtained when silica or titania was added in an amount of 0.1, 0.2, 1 or 5 mass % relative to the alumina particles (average particle size 0.4 μm) as the main component material of the membrane layer; and when zirconia was added in an amount of 0.1, 0.2, 1, 5, 25 or 50 wt % relative to the alumina particles as the main component material of the membrane layer.

Similar results were obtained when the average particle size of the aluminum powder as the main component material for the membrane layer was 0.01, 0.3, 0.5 or 1 μm. Similar results were obtained even when zirconia of 6 nm or 15 nm average particle sizes was used as the material for surface modification in combination with the aluminum powder of 0.01, 0.3, 0.4, 0.5 or 1 μm average particle size.

Evaluation was carried out for other types of the materials for surface modification (ceria, iron oxide and tungsten oxide). The same properties were obtained for these samples using silica, titania and zirconia.

It is shown from the above results that the membrane layer has the same properties as those of conventional one when the average particle size of the main component material is in the range of 0.01 to 1 μm; the average particle size of the material for surface modification is 1/10 or less to the average particle size of the main component material; and the material for surface modification is added in an amount of 0.1 to 50 mass % relative to the component material.

As described above, the ceramic filter of the present embodiment has the modified surface of the membrane layer, without losing required properties by the addition of the material for surface modification, and without generating defects in the membrane layer.

It is emphasized that it is possible to minimize the amount of the surface modification material added to the membrane layer formed on the porous support.

For the ceramic filter in which: the porous support is formed from particles containing the metal oxide as the main component; and the membrane layer is coated on the surface of the porous support and formed from particles containing the same kind of metal oxide as that of the porous support, the surface charge can be controlled appropriately by loading the different kind of metal oxide from that used as the main component for the membrane layer. This enables to enhance suppression of membrane fouling caused by foulants.

In the case where alumina is used as the main component of the porous support, for example, the surface charge of the ceramic filter is shifted to a negative side by using silica, titania, zirconia, ceria, iron oxide, tungsten oxide or a mixture of these metal oxides, or a metal oxide complex involving the metal elements of these metal oxides, as the different kind of metal oxide. It is thus possible to effectively suppress membrane fouling caused by negatively charged foulants.

Although alumina was used as the main component of the porous support in the above embodiment examples, it is possible to obtain the same effects as in the above embodiment examples even when any metal oxide other than alumina, such as silica, cordierite, titania, mullite, zirconia, spinel or a mixture of these metal oxides, is used as the main component of the porous support.

Although silica or titania was used as the material for surface modification in the above embodiment samples, the other metal oxide such as zirconia, ceria, iron oxide, tungsten oxide, a mixture of these metal oxides, or a metal oxide complex involving metal elements of these metal oxides (e.g. aluminosilicate or titaniasilicate), can be used for surface modification. Even in this case, it is possible to obtain the same effects as in the above embodiment examples.

Although a sol of the different kind of metal oxide was used for loading on the particles of the membrane layer in the above embodiment samples, it is possible to obtain the same effects as in the above embodiment examples even when the different kind of metal oxide in powder from is used for loading on the particles of the membrane layer.

The present invention is not limited to the above-mentioned embodiment. It is obvious to those skilled in the art that various changes and modifications can be made as appropriate, which fall within the scope of the present invention.

For example, the ceramic filter may be formed with multiple membrane layers on the porous ceramic support. In the case where the average pore size of the support is large, the membrane layer may be formed on the support via an intermediate layer. Further, it is possible to form an additional layer on the surface of a membrane layer of a conventional ceramic filter in order to suppress membrane fouling. In the case where the ceramic filter is formed with multiple membrane layers, the particles of the top membrane layer should be coated with the material for surface modification to suppress membrane fouling.

It is possible to produce the ceramic filter with required properties such as pore size and without generating defects in the membrane layer by using conventional production process without modification of the production process in large extent.

Although the ceramic filter had a flat-sheet shape in which the membrane layer was formed on the inner surface of the channels made in parallel in the porous support or on the outer surface of the porous support in each of the above embodiment examples, it is possible to obtain the same effects as in the above embodiment examples even when the ceramic filter has any other configuration e.g. a hollow tube in which the membrane layer is formed on an inner or outer surface of the porous support, or a monolith shape in which the membrane layer is formed on inner surfaces of holes or on outer surface of the porous support.

1.-7. (canceled)

8. A ceramic filter for filtration of water containing foulants, the ceramic filter comprising:
a porous support formed from particles containing a metal oxide as a main component; and
a membrane layer coated on a surface of the porous support and formed from particles containing the same metal oxide as that of the porous support,
wherein the particles forming the membrane layer are loaded with a different kind of metal oxide from that of the particles forming the membrane layer such that a surface charge of the membrane layer is of the same polarity as a charge of the foulants and is shifted to a negative side relative to that of a membrane layer consisting of particles of the same metal oxide as that of the porous support.

9. The ceramic filter according to claim 8,
wherein the metal oxide contained as the main component of the porous support is alumina, silica, cordierite, titania, mullite, zirconia, spinel or a mixture thereof.

10. The ceramic filter according to claim 8,
wherein the different kind of metal oxide is silica, titania, zirconia, ceria, iron oxide, tungsten oxide or a mixture thereof.

11. The ceramic filter according to claim 8,
wherein the metal oxide contained as the main component of the membrane layer has an average particle size of 0.01 to 1 μm;
wherein the different kind of metal oxide has an average particle size smaller than or equal to 1/10 of the average particle size of the metal oxide contained as the main component of the membrane layer; and
wherein the different kind of metal oxide is added in an amount of 0.1 to 50 mass % relative to the amount of the metal oxide contained as the main component of the membrane layer.

12. The ceramic filter according to claim 8,
wherein the ceramic filter has multiple membrane layers; and
wherein the different kind of metal oxide is loaded on the surfaces of the particles of the metal oxide forming at least the top membrane layer.

13. The ceramic filter according to claim 8,
wherein the porous support has a hollow tube shape, a flat plate shape or a monolith shape; and
wherein the membrane layer is coated on an inner surface of one hole or holes formed in parallel in the porous support or on an outer surface of the porous support.

14. The ceramic filter according to claim 8,
wherein a sol or powder of the different kind of metal oxide is used for loading the metal oxide on the surfaces of the particles of the metal oxide forming the membrane layer.
